(19) United States
(12) Patent Application Publication
(10) Pub. No.: US 2026/0163999 A1
(43) Pub. Date: Jun. 11, 2026

(54) PROJECTOR DEVICE FOR CREATING SMOOTH DYNAMIC VISUAL EFFECTS IN PROJECTED IMAGES

(71) Applicant: HON YU AUTO PARTS CO., LTD., NEW TAIPEI CITY (TW)

(72) Inventors: YIN-TENG HSIAO, NEW TAIPEI CITY (TW); CHANG-AN YANG, NEW TAIPEI CITY (TW)

(21) Appl. No.: 19/209,802

(22) Filed: May 16, 2025

(30) Foreign Application Priority Data
Dec. 11, 2024 (TW) 113148259

(51) Int. Cl. H04N 9/31; B60Q 1/50

(52) U.S. Cl. CPC H04N 9/3155; H04N 9/3147; H04N 9/3164; B60Q 1/50; B60Q 2400/50; H04N 9/317

(57) ABSTRACT

A projector device that creates smooth dynamic visual effects in projected images includes a projector module and a light source controller. The projector module projects one or more images onto a target area to create spatially displaced projected images, partially overlapped projected images, symmetrical projected images, and/or projected images that complement each other. The light source controller gradually varies the brightness of light-emitting elements and introduces a time delay between them, enabling their brightness to vary asynchronously. This gradual and asynchronous variation in brightness across the projected images results in smooth dynamic visual effects.

### TECHNICAL FIELD

The present disclosure relates to a projector device that can be installed on vehicles (e.g., automobiles or motorcycles), that projects one or more images onto a target area, and that gradually varies the brightness of light-emitting elements while applying a time delay between them, resulting in smooth dynamic visual effects in the projected images.

### PRIOR ART

To improve warning functions and/or enhance aesthetics, vehicles are equipped with a projector device mounted on the exterior (such as side mirrors, door handles, or other areas). The projector device projects one or more images on the ground near the vehicle. For example, when a passenger opens a door or unlocks it using a remote control, the projector device projects the one or more images on the ground for a certain period of time.

The projector device projects an image formed on a light-transmissible sheet disposed in its housing. Light from a light-emitting element passes through the light-transmissible sheet, projecting the image onto a target area.

Conventional vehicle projector devices have either a single-lens or dual-lens configuration. A single-lens projector device projects a single image. In contrast, a dual-lens projector device includes two light-transmissible sheets, each formed with an image, disposed in its projector housing. By selectively turning its light-emitting elements on and off, the dual-lens projector device alternates between the images, creating dynamic visual effects in the projected images.

However, while the dual-lens projector device creates some dynamic visual effects, they do so only by alternating between static images. This causes interruptions or breaks in the visual flow, making the transitions less smooth.

### SUMMARY OF THE INVENTION

In view of the above, an example objective of the present disclosure is to provide a projector device that can be installed on a vehicle and that projects images with smooth dynamic visual effects.

To achieve the above example objective, the present disclosure proposes a projector device that differs from prior art and that project images with smooth dynamic visual effects. The projector device comprises a projector module including a first projector unit and a second projector unit adjacent each other and a substrate unit proximate the first and second projector units.

Each projector unit has a projector tube (first and second projector tubes). Each projector tube includes a lens assembly and a light-transmissible sheet. In certain embodiments, an image is formed on each light-transmissible sheet such that the images are identical, symmetrical, and/or complementary.

The substrate unit includes at least one light-emitting element that directs light into the first and second projector tubes. As the light passes through the lens assembly and the light-transmissible sheet of each projector tube, images are projected onto a target area.

A light source controller varies the brightness of the light-emitting elements over a predetermined time period. For example, each light-emitting element gradually increases in brightness from a minimum to a maximum level, then gradually decreases back to the minimum level, repeating this cycle over predetermined time period. To enhance the dynamic visual effects in the projected images, a time delay is introduced between the light-emitting elements so that their brightness varies asynchronously. This gradual and asynchronous variation in brightness across the projected images creates smooth dynamic visual effects.

Based on the above description, the present disclosure comprises a projector module that includes one or more projector units, a substrate unit, and a light source controller. The construction as such allows projection of one or more images onto a target area while gradually and/or asynchronously varying the brightness of one or more light-emitting elements, resulting in smooth dynamic visual effects in the projected images.

In certain embodiments, the duration of the variation in the brightness for a light-emitting element includes:
a first phase, during which the light-emitting element remains at 100% brightness;
a second phase, during which the light-emitting elements cycle through gradual variations in their brightness; and
a third phase, during which the light-emitting elements return to 100% brightness.

During the second phase, first and second light-emitting elements may undergo one or more cycles of gradually varying brightness in an asynchronous manner. For example, the first light-emitting element gradually dims from its maximum to minimum level. After a time delay, the second light-emitting element gradually brightens from the minimum to maximum level. The light-emitting elements then remain at their respective brightness level. Next, the second light-emitting element gradually dims back to the minimum level. After the time delay, the first light-emitting element gradually brightens back the maximum level. The light-emitting element then again remain at their respective brightness level. This cycle may repeat over a time period.

The substrate unit further includes:
a first substrate adjacent the first projector unit and formed with at least one light-emitting element that directs light into the first projector tube; and
a second substrate adjacent the second projector unit and formed with at least one light-emitting element that directs light into the second projector tube.

In at least one embodiment, the image on each light-transmissible sheet may include text, graphics, symbols, or combinations thereof.

In such at least one embodiment, the image on each image light-transmissible sheet can be either colored or monochromatic.

In certain embodiments, the projector module may further include one or more additional projector units, such as a third projector unit. In such configuration, the gradual brightness variation of the first, second, and third light-emitting elements is offset by a time delay. As a result, this time delay enhances the projected images, creating smooth dynamic visual effects.

The following detailed descriptions of embodiments highlight the exemplary features and advantages of the present disclosure. The content is sufficient for those skilled in the art to understand and implement the present disclosure. Based on the disclosed content, claims, and accompanying drawings, any skilled individual in the field can easily comprehend the purposes and benefits of the present disclosure.

### BRIEF DESCRIPTON OF THE DRAWINGS

FIG. 1 is a schematic diagram illustrating an exemplary projector module according to the various embodiments of the present disclosure;

FIG. 2 is a schematic diagram illustrating another projector module projecting an image onto a target area according to various embodiments of the present disclosure;

FIG. 3 is a schematic diagram illustrating another exemplary projector module installed on a vehicle and projecting an image on a ground according to the various embodiments of the present disclosure;

FIG. 4A is a schematic diagram illustrating an exemplary projected image in a target area according to the various embodiments of the present disclosure;

FIG. 4B is a schematic diagram illustrating another exemplary projected image on a target area according to the various embodiments of the present disclosure;

FIG. 5A is a schematic diagram illustrating another exemplary projected image in a target area according to the various embodiments of the present disclosure;

FIG. 5B is a schematic diagram illustrating another exemplary projected image in a target area according to the various embodiments of the present disclosure;

FIG. 6A is a schematic diagram illustrating another exemplary projected image in a target area according to the various embodiments of the present disclosure;

FIG. 6B is a schematic diagram illustrating another exemplary projected image in a target area according to the various embodiments of the present disclosure;

FIG. 7 is a schematic diagram illustrating exemplary time periods during which the brightness of light sources of a projector module gradually increases and decreases according to the various embodiments of the present disclosure; and

FIG. 8 is a schematic diagram illustrating another exemplary time periods during which the brightness of light sources of a projector module gradually increases and decreases according to the various embodiments of the present disclosure.

### EMBODIMENT

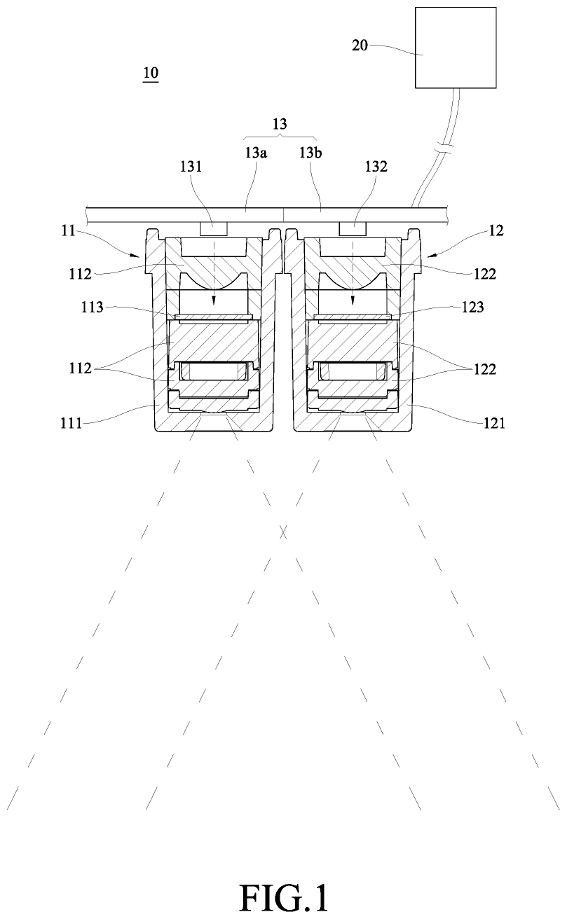

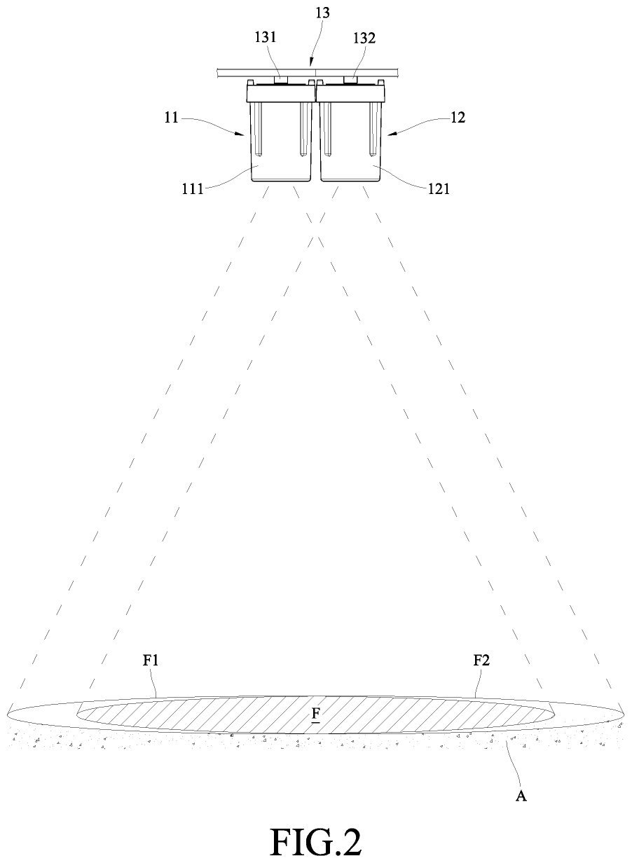

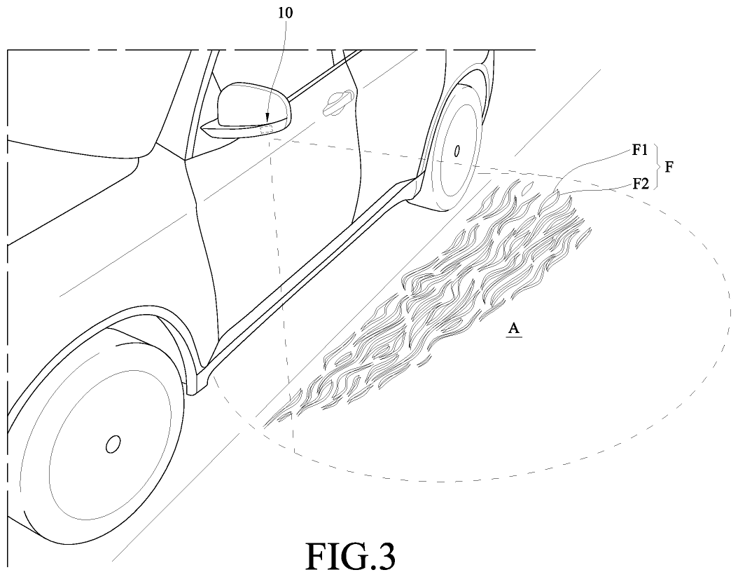

Please refer to FIGS. 1 to 3. FIG. 1 is a schematic diagram illustrating an exemplary projector module according to the various embodiments of the present disclosure. FIG. 2 is a schematic diagram illustrating another projector module projecting an image onto a target area according to various embodiments of the present disclosure. FIG. 3 is a schematic diagram illustrating another exemplary projector module installed on a vehicle and projecting an image on a ground according to the various embodiments of the present disclosure. The present disclosure describes a projector device configured to be installed on vehicles, e.g., automobiles or motorcycles. The projector device projects one or more images on a target area (A), such as a surface of a road or the floor inside a vehicle. By gradually varying the brightness of one or more light-emitting elements and by applying a time delay between the light-emitting elements, their brightness varies asynchronously, resulting in smooth dynamic visual effects in the projected images.

In this exemplary embodiment, the projector device comprises a projector module (10) and a light source controller (20). The projector module (10) projects a plurality of images on a target area (A). The light source controller (20) varies the brightness of the light sources gradually in an asynchronous manner, creating smooth visual effects in images projected by the projector module (10).

As shown in FIG. 1, the projector module (10) includes a first projector unit (11), a second projector unit (12), and a substrate unit (13). The first and second projector units (11, 12) are adjacent each other and parallel to one another. Each projector unit (11, 12) includes a first and second projector tube (111, 121). Each projector tube (111, 121) houses a lens assembly (112, 122) and a light-transmissible sheet (113, 123).

In certain embodiments, the light-transmissible sheet (113, 123) of each projection tube (111, 121) is formed with an image. In such certain embodiments, the images may be identical and are spatially displaced when projected. In some embodiments, the projected images are symmetrical. In other embodiments, the projected images complement each other.

In one implementation, the image of at least one of the light-transmissible sheets (113, 123) may include text, graphics, symbols, or combinations thereof. In such one implementation, the image can be either colored or monochromatic.

The substrate unit (13) is proximate the first and second projector units (11, 12) and is formed with at least one light-emitting element (131, 132) that directs light into the first and second projector tubes (111, 121). In each projector tube (111, 121), the lens assembly (112, 122) focuses the light from the at least one light-emitting element (131, 132), which then passes through the light-transmissible sheet (113, 123). As a result, images (F1, F2) are simultaneously projected onto a target area (A), forming spatially displaced projected images (F1, F2), symmetrical projected images (F1, F2), and/or projected images (F1, F2) that complement each other.

For example, the substrate unit (13) includes a first substrate (13a) and a second substrate (13b), each formed with at least one light-emitting element (131, 132). The first substrate (13a) is adjacent the first projector unit (11) and the at least one light-emitting element (131) directs light into the first projector tube (111). Similarly, the second substrate (13b) is adjacent the second projector unit (12) and the at least one light-emitting element (132) that directs light into the second projector tube (121).

The light source controller (20) gradually varies the brightness of the light-emitting elements (131, 132) and applies a time delay between the light-emitting elements (131, 132) through wired or wireless connections. During a predetermined time period, each light-emitting element (131, 132) gradually increases in brightness from a minimum to a maximum level, then gradually dims back to the minimum level. This cyclical variation in brightness may repeat a one or more times over the predetermined time period.

It should be noted that the light-emitting elements (131, 132), each directing light into the respective projector tubes (111, 121) to project image (F), are offset by a time delay, resulting in asynchronous gradual variations in their brightness. As a result, the images (F1, F2) projected by the first and second projector tubes (111, 121) onto the target area (A) exhibit smooth dynamical visual effects.

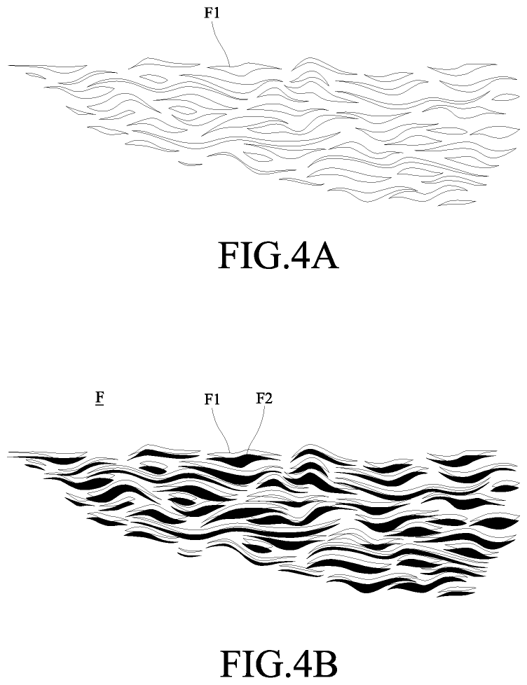

Please refer to FIGS. 4A and 4B. FIG. 4A is a schematic diagram illustrating an exemplary projected image (F1) in a target area according to the various embodiments of the present disclosure. FIG. 4B is a schematic diagram illustrating another exemplary projected image (F) on a target area according to the various embodiments of the present disclosure. As illustrated in FIGS. 4A and 4B, the projected images (F1, F2) are identical, spatially displaced, and/or partially overlapping, resulting in the projected image (F) in the target area (A).

In this exemplary embodiment, the light-emitting elements, each projecting the respective image (F1, F2), are offset by a time delay, resulting in asynchronous gradual variations in their brightness. As this cycle of varying brightness repeats one or more times over a predetermined time period, the projected image (F) exhibits asynchronous brightness variations, resulting in smooth dynamic visual effects.

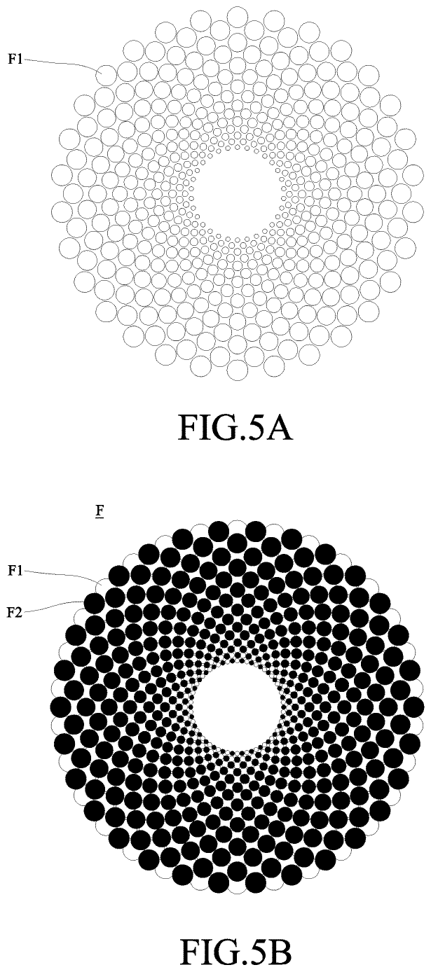

FIG. 5A is a schematic diagram illustrating another exemplary projected image (F1) in a target area (A) according to the various embodiments of the present disclosure. FIG. 5B is a schematic diagram illustrating another exemplary projected image (F) in a target area (A) according to the various embodiments of the present disclosure. As illustrated in FIGS. 5A and 5B, the projected images (F1, F2) are identical, spatially displaced, and/or partially overlapping such that the projected image (F2) is rotated relative to the projected image (F1), resulting in the projected image (F) in the target area (A).

In this exemplary embodiment, the light-emitting elements, each projecting the respective image (F1, F2) are offset by a time delay, resulting in asynchronous gradual variations in their brightness. As this cycle of varying brightness repeats one or more times over a predetermined time period, the projected image (F) exhibits asynchronous brightness variations, resulting in smooth dynamic visual effects.

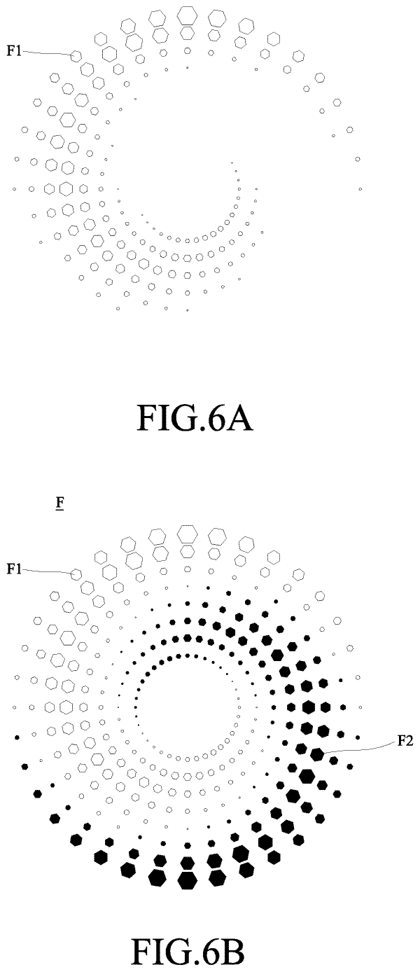

Please refer to FIGS. 6A and 6B. FIG. 6A is a schematic diagram illustrating another exemplary projected image (F1) in a target area (A) according to the various embodiments of the present disclosure. FIG. 6B is a schematic diagram illustrating another exemplary projected image (F) in a target area (A) according to the various embodiments of the present disclosure. As illustrated in FIGS. 6A and 6B, the projected images (F1, F2) are symmetrical, partially overlapping, and/or complement each other, resulting in the projected image (F) in the target area (A).

In this exemplary embodiment, the light-emitting elements, each projecting the respective image (F1, F2), are offset by a time delay, resulting in asynchronous gradual variations in their brightness. As this cycle of varying brightness repeats one or more times over a predetermined time period, the projected image (F) exhibits asynchronous brightness variations, resulting in smooth dynamic visual effects.

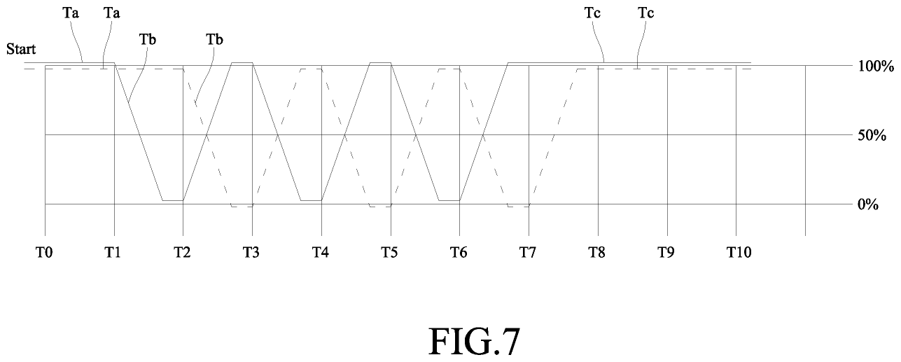

FIG. 7 is a schematic diagram illustrating exemplary time periods during which the brightness of light-emitting elements of a projector module gradually increases and decreases according to the various embodiments of the present disclosure. In an exemplary operation, each light-emitting elements (131, 132) directs light into its respective projector tubes (111, 121) to project images (F1, F2). The light source controller (20) gradually varies their brightness and introduces a time delay between them, creating asynchronous variations in their brightness. This cycle repeats one or more times over a time period (Tb).

As shown in FIG. 7, the light-emitting elements (131, 132) are controlled by the light source controller (20) to adjust their brightness periodically over three time periods (Ta-Tc). During the first time period (Ta), the brightness remains at about 100%. During the second time period (Tb), the light-emitting elements (131, 132) gradually decrease and increase their brightness asynchronously one or more times. Finally, during the third time period (Tc), the brightness returns to about 100% and remains substantially constant for its duration. This cycle may repeat one or more times.

Consequently, the repeating pattern of adjusting the brightness of the light-emitting elements (131, 132) can be divided into three stages: the first stage corresponds to the first time period (Ta), the second stage to the second time period (Tb), and the third stage to the third time period (Tc).

During the second stage, the light-emitting elements (131, 132) gradually vary their brightness with a time delay. For example, the light-emitting element (131) begins to gradually vary its brightness at time (T1), while the light-emitting element (132) starts after a delay following time (T1).

During this stage, each light-emitting element (131, 132) completes one or more cycles of brightness variation. As shown, each cycle includes: gradually dimming from 100% (fully lit) to 0% (fully dimmed), remaining dimmed for a predetermined duration, and gradually brightening back to 100%, where it stays fully lit before repeating the cycle.

The brightness variations in the second stage, which occurs during the second time period (Tb), may be repeated one or more times depending on control settings before transitioning to the third stage, which takes place during the third time period (Tc).

During the transition to the third stage, the light-emitting elements (131, 132) gradually vary their brightness through the first and second projector tubes (111, 121). This creates an illusion of motion in the projected image (F). For example, the projected image (F) may appear floating, rotating, swaying, or flowing.

In one implementation, the duration of the second stage (Tb) is at least 3 seconds, e.g., ranging between 5 and 10 seconds. In an alternative implementation, the duration of the second stage (Tb) may be less than 3 seconds. In such an alternative implementation, the brightness varies at a faster rate.

In one implementation, the projector module (10) of the present disclosure may include one or more projector units in addition to the first and second projector units (11, 12). For example, in some embodiments, it may include a third projector unit (not shown). In such some embodiments, the third projector unit has substantially the same structure as the first and second units (11, 12) and includes a substrate unit (13) formed with at least one light-emitting element disposed in its projector tube. This allows three images to be projected simultaneously onto the target area (A), creating spatially displaced projected images, partially overlapped projected images, and/or projected images that complement each other. In other embodiments, the projector module (10) includes two or more additional projector units arranged in parallel to the first and second projector units (11, 12) and adjacent to each other.

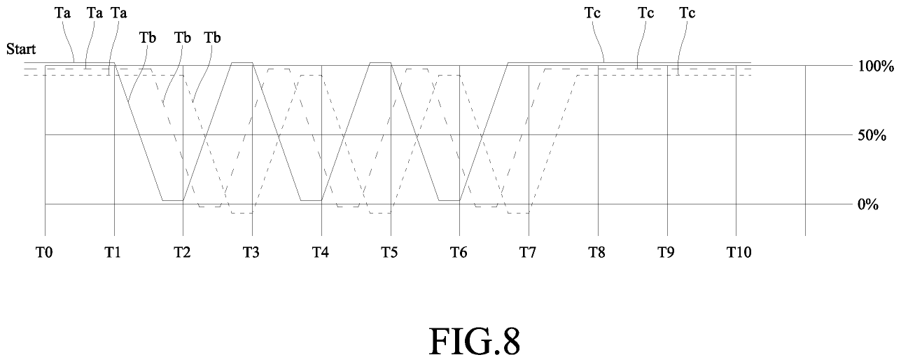

FIG. 8 is a schematic diagram illustrating another exemplary time periods during which the brightness of light-emitting elements of a projector module gradually increases and decreases according to the various embodiments of the present disclosure. In at least one embodiment, the projector module (10) includes three adjacent projector units. In such at least one embodiment, the light source controller (20) gradually varies their brightness asynchronously in one or more repeating cycles.

As shown in FIG. 8, when the three light-emitting elements are activated by the light source controller (20), their brightness are adjusted over a sequence of time periods (Ta, Tb, Tc). For example, during the first time period (Ta), the brightness remains at about 100%. Then, during the second time period (Tb), the light-emitting elements (131, 132) gradually vary their brightness asynchronously in one or more cycles. Once the second time period (Tb) elapses, each light-emitting element returns to about 100% brightness over the third time period (Tc). After completing the time periods (Ta, Tb, Tc), the cycle repeats one or more times.

From the above description, the projector module (10) includes a plurality of projector units, a substrate unit (13), and a light source controller (20). The projector units simultaneously project images onto a target area (A) using projector tubes. By introducing a time delay between the light-emitting elements (131, 132), the brightness gradually varies in asynchronous manner, creating the illusion of motion in the projected images (F).

Although the projector device is exemplified as projecting a plurality of images, it should be understood that, after reading this disclosure, the projector device may project a single image while gradually varying the brightness of its projector module to create an illusion of motion in the projected image.

The above description merely presents exemplary embodiments of the present disclosure and does not limit its scope. Any equivalent modifications or changes made within the scope of the are also included.

What is claimed is:

1. A projector device configured to create smooth dynamic visual effects in projected images, the projector device comprising:
a projector module including:
first and second projector units adjacent each other, wherein:
each projector unit has a projector tube;
the projector tube includes a lens assembly and a light-transmissible sheet;
the light-transmissible sheet is formed with an image;
the images are spatially displaced, symmetrical, and/or complement each other;
a substrate unit proximate the first and second projector units and formed with first and second light-emitting elements, wherein:
each light-emitting element is configured to direct light into the projector tube;
the lens assembly is configured to focus the light on the projector tube through the light-transmissible sheet, simultaneously projecting the images onto a target area and creating spatially displaced projected images, symmetrical projected images, and/or projected images that complement each other; and
a light source controller configured to gradually vary brightness of each light-emitting element and to introduce a time delay between the light-emitting elements to gradually vary the brightness in an asynchronous manner, resulting in smooth dynamic visual effects in projected images, wherein the light-emitting elements are configured to cycle between completely dimmed and full brightness over a predetermined time period.

2. The projector device of claim 1, wherein the brightness of the light-emitting elements varies across a plurality of phases including:
a first phase, during which the light-emitting elements maintain full brightness (100%) for a first time period; and
a second phase, during which the light-emitting elements cycle through gradual brightness variations a predetermined number of times for a second time period.

3. The projector device of claim 2, wherein, in the second phase, the light-emitting elements cycle through gradual brightness variations in an asynchronous manner.

4. The projector device of claim 3, wherein each light-emitting element is configured to gradually decrease its brightness from full brightness to fully dimmed, to remain dimmed for a first predetermined duration, to gradually increase its brightness back to full, and to maintain full brightness for a second predetermined duration.

5. The projector device claim 2, wherein a duration of the second phase is at least 3 seconds.

6. The projector device of claim 5, wherein a duration of the second phase ranges between about 5 seconds and about 10 seconds.

7. The projector device of claim 2, wherein the plurality of phases further includes a third phase, during which each light-emitting element returns to full brightness for a third time period.

8. The projector device of claim 1, wherein the substrate unit further includes:
a first substrate adjacent the first projector unit and formed with at least one light-emitting element configured to direct light into the first projector tube; and
a second substrate adjacent the second projector unit and formed with at least one light-emitting element configured to direct light into the second projector tube.

9. The projector device of claim 1, wherein the image on at least one of the light-transmissible sheets includes text, graphics, symbols, or combinations thereof.

10. The projector device of claim 1, wherein the image on at least one of the light-transmissible sheets are either colored or monochromatic.
